(19) United States
(12) Patent Application Publication
(10) Pub. No.: US 2006/0114247 A1
(43) Pub. Date: Jun. 1, 2006

(54) Apparatus for measuring a capacitance and sensor array

(76) Inventor: Chris J. Brown, Oxford (GB)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 11/267,967

(22) Filed: Nov. 7, 2005

(30) Foreign Application Priority Data
Nov. 9, 2004 (GB) 0424688.0

(51) Int. Cl. G09G 5/00

(52) U.S. Cl. 345/204

(57) ABSTRACT

A capacitance measuring apparatus is provided, for example for measuring variations in pixel capacitance of an active matrix liquid crystal display to provide a “touch screen” function. The apparatus comprises a capacitor network having a plurality of states presenting different capacitances. A sense amplifier compares a capacitance to be measured with the capacitance of the network and a comparator supplies an output indicating whether the capacitance to be measured is larger or smaller than the capacitance of the network. A control circuit causes the network to switch through its states and monitors the output of the comparator so as to select the state of the network presenting a capacitance adjacent the capacitance to be measured. The digital measurement corresponding to the capacitance presented by the network is supplied to an output and provides a measure of the capacitance to be measured.

### TECHNICAL FIELD

The present invention relates to an apparatus for measuring a capacitance. Such an apparatus may be used, for example, to measure capacitance where only a single terminal of the capacitance is available or accessible and an example of this is the measurement of pixel and data or “source” line capacitance in active matrix liquid crystal displays. The present invention also relates to a sensor array, for example in the form of an active matrix display, including one or more such measuring apparatuses.

### BACKGROUND

Active matrix liquid crystal displays (AMLCDs) may be used in products that require an input function. For example, mobile phones and Personal Data Organizers (PDAs) may display information to a user on an AMLCD and also require input from the user, such as from a telephone keypad. Historically, sensor functionality has been achieved by adding extra components to the display module. For example, a conventional means to achieve touch input is to add an extra device in front of the display.

U.S. Pat. No. 6,028,581 discloses an AMLCD with integrated sensor that may be used to accept touch or image input. Sensor functionality is achieved through the incorporation of a photodiode within each pixel. Although this display achieves some cost and performance benefits, for example no additional layers are required, these benefits are offset by the reduced pixel fill factor and complexity of the active matrix design which must include extra control lines for the photodiode as well as an additional TFT, photodiode and micro-lens at each pixel. In addition, the display does not include analogue-to-digital converters “on panel”, thus increasing the cost and complexity of the display interface.

JP5-250093 discloses an AMLCD with integrated co-ordinate detection apparatus that may be used to accept touch input. Positional information is input to the active matrix through the use of a pen which generates a voltage that, when touched directly onto the display, changes the state of the pixel underneath. Although this system requires no substantial modification to the active matrix, and hence no degradation in image quality, the use of a specialised ‘active’ pen is undesirable

EP1455264 discloses an AMLCD with integrated sensor capable of utilising the active matrix as an input means with no substantial modification to the matrix and without any external components. Sensor circuits are integrated onto the display substrate and connected to the display source lines. Such sensor circuits may include a charge transfer amplifier and charge-redistribution analogue-to-digital converter (ADC). These circuits are arranged to measure the state of each pixel in the display upon application of suitable driving waveforms. In particular, the charge transfer amplifier is used to measure the pixel capacitance, which may change as the user presses the display and alters the liquid crystal cell gap. The amplifier operates by comparing the pixel capacitance (plus the parasitic capacitance of the source line to which it is attached) to a dummy capacitor and outputting a voltage corresponding to this capacitance difference. This voltage is converted to a digital output by the ADC.

A disadvantage of this arrangement is that the output of the amplifier is sensitive to process variation in the source line, dummy capacitor and TFTs leading to reduced range and accuracy compared to the ideal. Further, extreme process variation can lead to permanent saturation of the amplifier output resulting in the malfunction of the integrated sensor circuits. It is possible to mitigate the effects of such process variation by optimising the circuit design parameters to increase the range of the sense amplifier. This can only be achieved, however, at the expense of a loss in accuracy.

### SUMMARY

According to a first aspect of the invention, there is provided an apparatus for measuring a capacitance, comprising a capacitor network having a plurality of states presenting respective different capacitances, a sense amplifier for comparing the capacitance to be measured with the capacitance of the network and for supplying an output representative of whether the capacitance to be measured is larger or smaller than the capacitance of the network, and a control circuit responsive to the output of the sense amplifier to select among the states of the network and to supply a digital measurement output corresponding to the state in which the network has a capacitance adjacent the capacitance to be measured.

The sense amplifier may have a measurement cycle comprising charging the capacitance to be measured and the capacitor network to the same voltage, changing the charges in the capacitance to be measured and in the capacitor network by the same amount, and comparing the voltages on the capacitance to be measured and the capacitor network. The sense amplifier may comprise a charge transfer amplifier.

The capacitor network may comprise a plurality of capacitors connected in parallel via respective electronic switches. The capacitors may have binary-weighted capacitances. The capacitor network may comprise a further permanently connected capacitor.

The apparatus may comprise a voltage comparator connected to the output of the sense amplifier. The voltage comparator may comprise a dynamic latch.

The apparatus may comprise a memory for storing a calibration value from the control circuit during a calibration phase of operation and for presenting the calibration value to the capacitor network at the start of a measurement phase of operation.

The control circuit may comprise a counter whose outputs are arranged to select the capacitor network states. The counter may be arranged to step monotonically through the capacitances until the output of the sense amplifier changes state.

The control circuit may comprise a successive approximation register whose outputs are arranged to select the capacitor network states.

According to a second aspect of the invention, there is provided a sensor array comprising: an array of sensor elements, each of which comprises an electrode for cooperating with an overlying material to form a capacitor; at least one apparatus according to the first aspect of the invention; and a switching network for connecting the electrodes to the at least one apparatus.

The network may be arranged to connect the electrodes one at a time to the or each apparatus.

The network may comprise an active matrix. The array may comprise: an active matrix display in which the sensor elements comprise picture elements arranged as rows and columns, each picture element having a display data input for receiving image data to be displayed and a scan input for enabling input of image data from the data input, the data inputs of the picture elements of each column being connected to a respective column data line and the scan inputs of the picture elements of each row being connected to a respective row scan line; a data signal generator for supplying data signals to the column data lines; a scan signal generator for supplying scan signals to the row scan lines; and an output arrangement connected to the column data lines and responsive to sensor signals generated by and within the display picture elements in response to external stimuli, the output arrangement comprising the at least one apparatus for measuring data line and picture element capacitance.

The array may comprise a display substrate on which are integrated the data signal generator, the scan signal generator, the output arrangement, and electronic components of the array.

Each picture element may comprise an image generating element and an electronic switch. Each image generating element may comprise a liquid crystal element.

The or each apparatus may be arranged to perform the calibration phase periodically in the absence of external stimuli. The or each apparatus may be arranged to perform the calibration phase at least at switch-on of the array.

It is thus possible to provide an arrangement of reduced complexity, size and power consumption as compared with known arrangements. Also, significant improvements in performance may be obtained. For example, the effect of process variation is reduced to provide an arrangement which is more robust to such variation.

### BRIEF DESCRIPTION OF THE DRAWINGS

FIG. 1 is a block schematic diagram of an active matrix display and sensor arrangement constituting an embodiment of the invention;

FIG. 2 is a block circuit diagram of a capacitance measuring apparatus constituting an embodiment of the invention and used in the arrangement of FIG. 1;

FIG. 3 is a flow diagram illustrating operation of the apparatus of FIG. 2;

FIG. 4 is a circuit diagram similar to FIG. 2 illustrating a capacitor network in more detail;

FIG. 5 is a diagram similar to FIG. 4 but illustrating a modified capacitor network;

FIG. 6 is a circuit diagram illustrating a sense amplifier as shown in FIG. 2;

FIG. 7 is a circuit diagram illustrating a comparator as shown in FIG. 2;

FIG. 8 is a block circuit diagram of a counter for use in a control logic as shown in FIG. 2;

FIG. 9 is a block circuit diagram of a successive approximation register for use in the control logic of FIG. 2;

FIG. 10 is a diagram similar to FIG. 2 illustrating a modification;

FIG. 11 is a flow diagram illustrating operation of the apparatus shown in FIG. 10; and

FIG. 12 is a block schematic diagram of a sensor array constituting an embodiment of the invention.

Like reference numerals refer to like parts throughout the drawings.

### DETAILED DESCRIPTION

The active matrix liquid crystal display and sensor apparatus is formed on a display substrate illustrated diagrammatically at 1 and comprises a timing and control circuit 2 connected to an input 3 for receiving timing and control signals together with image data to be displayed. The circuit 2 supplies the appropriate signals to a data signal generator in the form of a display source driver 4 and a scan signal generator in the form of a gate driver 5. The drivers 4 and 5 may be of any suitable type, such as of a standard or conventional type, and will not be described further.

The display source driver 4 has a plurality of outputs which are connected to but isolatable from a plurality of matrix column electrodes which act as column data lines for the active matrix of picture elements (pixels) indicated at 6. The display source driver outputs may, for example, only be connected to the data lines when the driver is enabled by the control circuit 2. The column electrodes extend throughout the height of the active matrix 6 and each is connected to data inputs of a respective column of pixels. Similarly, the driver 5 has a plurality of outputs connected to row electrodes which extend throughout the width of the matrix 6. Each row electrode acts as a row scan line and is connected to scan inputs of the pixels of the respective row.

One of the pixels is illustrated in more detail at 10 and is of a standard active matrix liquid crystal type. The pixel 10 comprises an electronic switch 11 in the form of a poly-silicon thin film transistor whose source is connected to the column electrode 12, whose gate is connected to the row electrode 13, and whose drain is connected to a liquid crystal pixel image generating element 14 and a parallel storage capacitor 15.

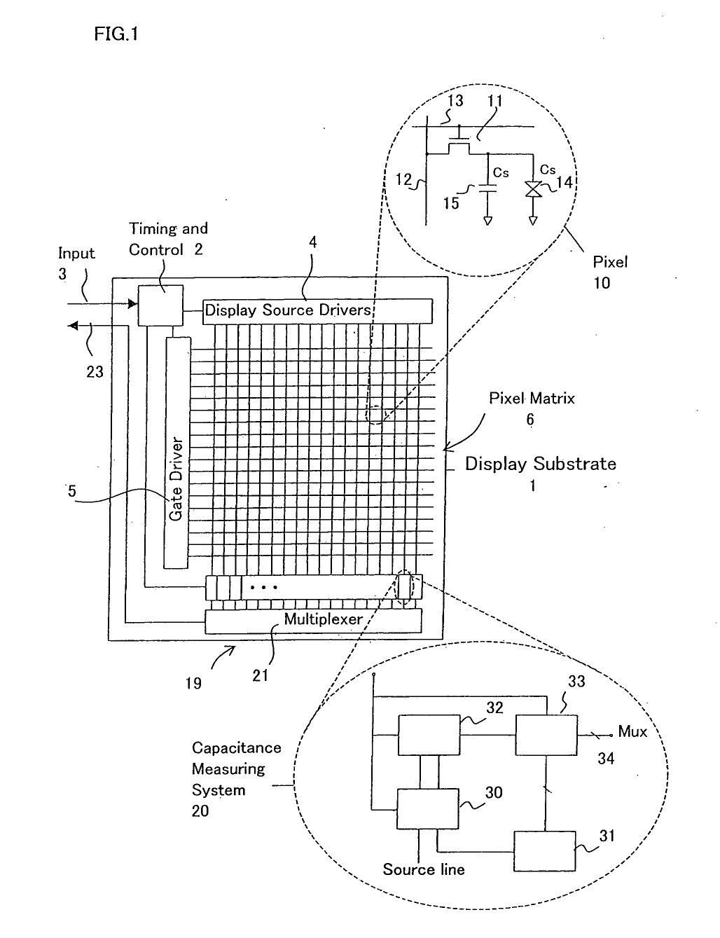

FIG. 1 illustrates diagrammatically the physical layout of the various parts of the arrangement. All of the electronics are integrated on the display substrate 1 with the display source driver 4 being disposed along the upper edge of the matrix 6 and the gate driver 5 being disposed along the left edge of the matrix 6. The drivers 4 and 5 and the matrix 6 and their relative dispositions may be standard or conventional.

The arrangement further comprises an output arrangement 19 which is disposed along the bottom edge of the matrix 6. The arrangement 19 comprises a plurality of capacitance measuring apparatuses or systems 20 which are controlled, for example enabled, by a control signal from the circuit 2 and whose inputs are connected to respective column electrodes. The outputs of the apparatuses 20 are supplied to a multiplexer 21, which supplies output signals to a sense output 23 of the arrangement.

The references to rows and columns are not intended to be limited to horizontal rows and vertical columns but, instead, refer to the standard well-known way in which image data are entered row by row. Although pixel rows are normally arranged horizontally and pixel columns vertically in displays, this is not essential and the rows could, for example, equally well be arranged vertically with the columns then being arranged horizontally.

In use, image data for display are supplied by any suitable source to the input 3 of the arrangement and are displayed by the active matrix 6 in accordance with the operation of the drivers 4 and 5. For example, in a typical arrangement where the display is refreshed row-by-row, pixel image data are supplied serially as image frames with a frame synchronisation pulse indicating the start of each frame refresh cycle. Rows of pixel image data are entered one after the other in the display source driver 4 and a scan signal is supplied to the appropriate row electrode for enabling the image data to be stored in the appropriate row of pixels. Thus, the pixel rows of the matrix 6 are refreshed a row at a time with the gate driver 5 usually supplying scan signals a row at a time starting at the top row and finishing at the bottom row when a frame refresh cycle has been completed.

In this mode of operation, each display frame includes a refresh part during which the display data are used to refresh the matrix 6 of pixels a row at a time followed by a vertical blanking period. At the end of the display frame period, a sensor frame synchronisation pulse is supplied to initiate a sensor frame or period forming a sense phase of the apparatus.

During the sense phase, outputs of the display source driver 4 are isolated from the column electrodes and the apparatuses 20 are enabled by the circuit 2. The gate driver 5 again scans the row electrodes one at a time in turn from the top of the matrix 6 to the bottom and the signals supplied by the apparatuses 20 are output via the multiplexer 21.

During the display phase, when the pixel 10 is being refreshed, the gate driver 5 supplies a scan signal to the row electrode 13, which thus turns on the thin film transistor 11. The display source driver 4 supplies a voltage representing the desired visual state of the image generating element simultaneously to the column electrode 12 and charge for determining the desired image appearance is transferred from the column electrode 12 to the storage capacitor 15 and to the image generating liquid crystal element 14, which also acts as a capacitor. The voltage across the element 14 causes this to display the desired image grey level in the known way. The liquid crystal pixel image generating element 14 comprises the optically variable region which gives rise to the display action.

Standard display pixels such as that illustrated at 10 may be used to sense external stimuli without requiring any substantial modification. For example, each display pixel may be used to detect a touch input, as described in T. Tanaka et al, “Entry of Data and Command for an LCD Direct Touch: An Integrated LCD Panel”, SID 1986. Pressure applied to the top glass plate of an LCD assembly causes deformation in the liquid crystal around the area to which pressure is applied. This deformation causes a detectable change in capacitance of the liquid crystal element 14. This change in capacitance represents a signal generated by and within the optically variable region of the liquid crystal element 14.

During the sense phase when the row containing the pixel 10 is enabled by the scan signal from the driver 5 on the row electrode 13, the element 14 together with the capacitor 15 are connected to the column electrode 12 by the transistor 11. Any variation of capacitance of the pixel as a result of an external stimulus is thus made accessible to the one of the apparatuses 20 connected to the column electrode 12 so that the altered capacitance resulting from the stimulus is converted to a digital value by the apparatus 20.

The cycle of operation is then repeated starting with the frame synchronisation pulse which initiates refreshing of the display with the next frame of display data. The display frame time may or may not be equal to the sensor frame time.

Although the sensor frame has been described as occurring after the vertical blanking period of the preceding display frame, the sensor frame may alternatively occur at some other time, for example within the blanking period of the display frame. All of the rows may be scanned for sensor data during the sensor frame. Alternatively, a different proper subset of the rows of pixels may be scanned during each of a plurality of frames such that the entire matrix is scanned for sensor data over the period of the plurality of display frames. For example, the number of rows scanned for sensor data may be dependent on the display frame rate and the patterns of scanned rows may be determined by software in the timing and control circuit 2. Such an arrangement may be used to provide an improvement in the quality of the displayed image, as compared with scanning the whole matrix during the sensor frame, and may allow the display to maintain as high a frame rate as for conventional displays which do not provide sensing functionality. The term “proper subset” as used herein is defined as being a subset of the full set, excluding the cases of the empty set and the full set.

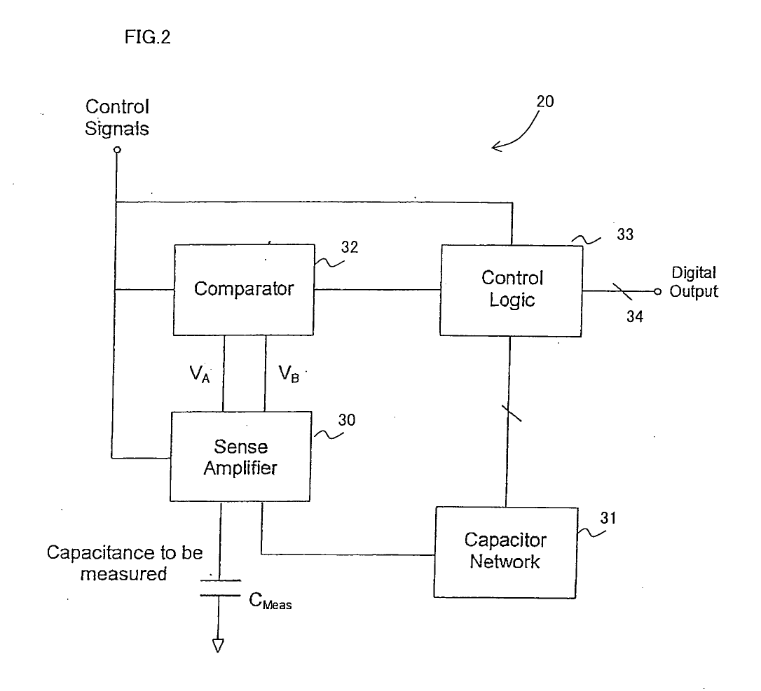

The capacitance measuring apparatus is illustrated in more detail in FIG. 2 and comprises a sense amplifier 30, a capacitor network 31, a comparator 32, and control logic 33. The sense amplifier 30 and the control logic 33 receive control signals from the circuit 2 or generated from signals received from the circuit 2. The control logic 33 supplies a parallel digital output signal representing measured capacitance at a digital output 34.

The capacitor network 31 is arranged such that, upon application of suitable control signals from the control logic 33, it takes one of a number of states, X. Each state x of the capacitor network 31 presents a different output capacitance, C_{Net,x}. The network may be arranged such that C_{Net,x+1}>C_{Net,x}.

The sense amplifier 30 has two inputs. The first input is connected to the output of the capacitor network (which presents a capacitance, C_{Net,x}). The second input is connected to the component to be measured (which presents a capacitance C_{Meas}). Upon application of suitable control signals to the sense amplifier 30, the amplifier operates in cycles such that one cycle of operation consists of a number of phases, including at least a hold phase. The amplifier 30 is further arranged to produce two output voltage signals V_{A} and V_{B}, such that, if C_{Net,x}<C_{Meas}, then, during the hold phase, V_{A}>V_{B}. Conversely, if C_{Net,x}>C_{Meas} then, during the hold phase, V_{B}>V_{A}.

The comparator 32 is arranged to output a digital signal corresponding to the relative magnitude of the sense amplifier outputs V_{B} and V_{A} such that, for example:
V_{A}>V_{B}=0
V_{A}<V_{B}=1

The control logic 33 is arranged such that a binary number corresponding to the value of the capacitor network is output as the comparator output changes state.

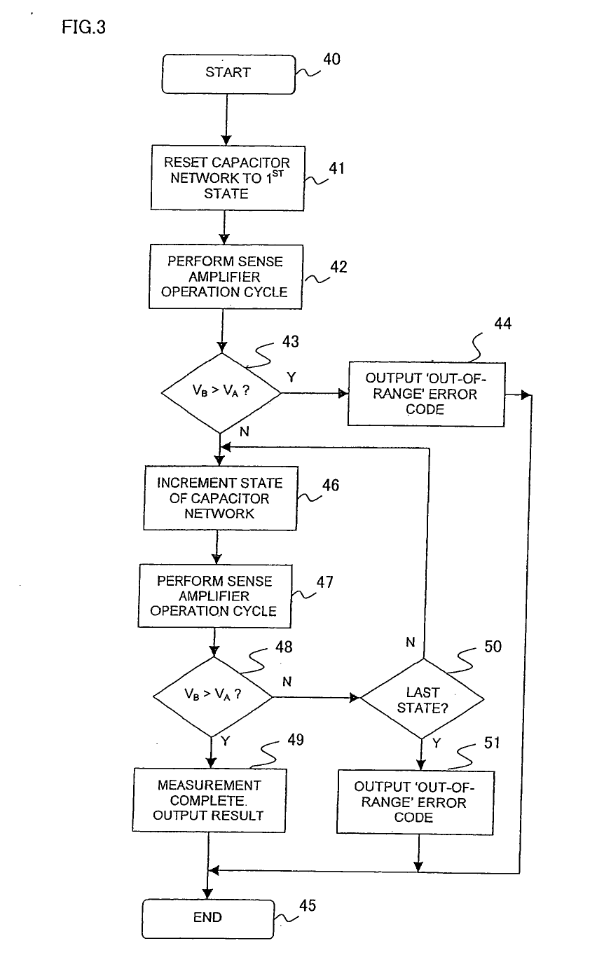

The capacitance measurement sequence performed by the above system is illustrated in FIG. 3 and starts at 40. The capacitor network is set to a 1^{st} state at 41, the comparator output is set low, and the control logic is reset. In this 1^{st} state, the capacitor network is arranged to present to the amplifier a capacitance, C_{Net,1}, nominally less than that of the capacitance being measured, C_{Meas}.

The sense amplifier 30 is then operated through a first cycle 42 of operation. If during this first cycle C_{Net,1}>C_{Meas}, the amplifier 30 generates output voltages during the hold phase such that V_{B}>V_{A} (43), the comparator output changes state to high and the conversion is complete but in error. The control logic 33 may be arranged to output (44) an error code indicating ‘out of range’ and operation ends at 45.

If, during first cycle C_{Net,1}<C_{Meas}, the amplifier 30 generates output voltages during the hold phase such that V_{A}>V_{B}, the comparator output remains low and the control logic 33 is arranged to switch the state of the capacitor network to a 2^{nd} state (46). The capacitance presented by the capacitor network in this 2^{nd} state, C_{Net,2}, is larger than that presented in the 1^{st} state, C_{Net,1}. The amplifier cycle of operation is then repeated at 47.

For every subsequent x^{th} sense amplifier cycle of operation where the capacitor network is in a state x, if C_{Net,x}>C_{Meas}, the amplifier 30 generates output voltages during the hold phase such that V_{B}>V_{A} (48), the comparator output changes state to high and the control logic 33 outputs (49) a binary number corresponding to the value of the capacitor network 31. The capacitance measurement sequence is complete.

If, during the x^{th} cycle C_{Net,x}<C_{Meas}, the amplifier 30 generates output voltages during the hold phase such that V_{A}>V_{B}, the comparator output remains low and the control logic 33 is arranged to switch the state of the capacitor network 31 to a (x+1)^{th} state. The capacitance presented by the capacitor network in this (x+1)^{th} state, C_{Net,x+1}, is larger than that presented in the x^{th} state, C_{Net,x}. The amplifier cycle of operation is then repeated.

If during the X^{th} sense amplifier hold phase (50) the comparator output remains low, the capacitance measurement is considered complete but in error. The control logic may be arranged to output an error code indicating ‘out of range’ (51).

The system may be described as ‘pseudo-digital’ since it is only the sign of the voltage difference, V_{A}−V_{B}, that is important (as opposed to the magnitude in the case of the analogue operation described in EP1455264). The comparator 32 converts this sign to a single bit used by the control logic 33. By performing multiple ‘pseudo-digital’ capacitance comparisons, as described above, to achieve capacitance measurement, it is possible to reduce the complexity, and hence size and power consumption, of the overall system compared to the prior art. For example, the comparator design constraints may be reduced compared to the case of analogue operation.

The effect of process variation is reduced by providing an increased range of operation without loss of accuracy. The accuracy of the system is limited only by the smallest difference in capacitance that may be reliably defined between two adjacent states of the capacitor network 31.

Although the capacitance measuring apparatus 20 is illustrated as being used on the panel of an active matrix liquid crystal display to detect variations in pixel capacitance caused by touching the display screen, the apparatus 20 may be used in any other application where convenient for measuring capacitance. The apparatus 20 is particularly useful for measuring capacitances where only one terminal of the capacitance is accessible, as in the case of AMLCDs as described hereinbefore.

The display shown in FIG. 1 has a respective capacitance measuring apparatus 20 for each data line 12 of the active matrix. However, it is possible to have fewer capacitance measuring apparatuses 20 than the number of data lines 12 with at least some of the apparatuses 20 being connected via respective multiplexers to several data lines 12.

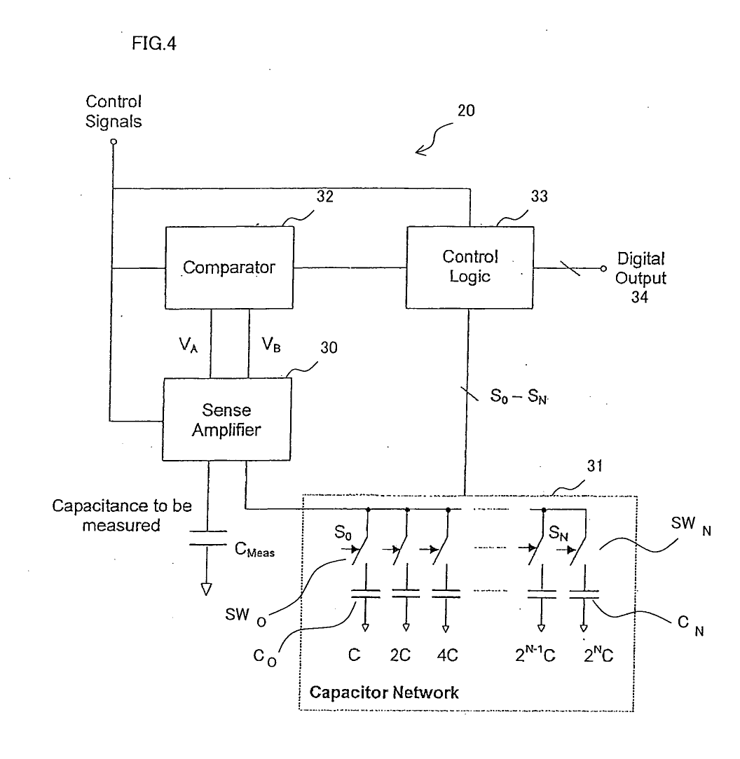

FIG. 4 illustrates an example of the capacitor network 31. In this example, the network 31 comprises (N+1) capacitors C₀, . . . , C_{N} and (N+1) electronic switches SW₀, . . . , SW_{N}, for example in the form of transmission gates. The control logic 33 supplies an (N+1) bit signal S₀, . . . , S_{N} representing a binary number whose least significant bit is S₀. Each bit controls a respective one of the switches so that the capacitors C₀, . . . , C_{N} are switchable in parallel in any combination. The capacitance of each capacitor Cᵢ is equal to 2° C., where C is the value of the smallest capacitor C₀ switched by the least significant bit S₀ of the control logic output. The network 31 thus comprises a binary weighted switched capacitor network.

The resolution of the apparatus 20 shown in FIG. 4 is equal to the value C of the smallest capacitor C₀. During operation, the control logic 33 steps the binary number represented by the bits S₀, . . . , S_{N} from a number representing 0 upwardly towards the maximum value of the number so that the capacitance presented by the capacitor network 31 increases in steps of C from 0, with all capacitors disconnected, towards the maximum value where all of the capacitors C₀, . . . , C_{N} are connected in parallel. The capacitance of the network 31 is incremented until the difference between the output voltages V_{A} and V_{B} of the sense amplifier 30 changes polarity, at which point the measurement of the capacitance to be measured is complete and the control logic 33 outputs the number represented by the current state of the bits S₀, . . . , S_{N}, or a number which is a function of this, at the digital output 34.

Although the capacitor network 31 is shown as being binary-weighted, other examples may be non-binary weighted, for example in order to produce a defined non-linear response.

In order to achieve a high resolution, a relatively large number of capacitors C₀, . . . , C_{N} is required. The capacitor network 31 and the control logic 33 thus require a substantial area of the substrate 1. Also, the complexity of the control logic is related to the number of capacitors in the capacitor network 31. Further, the time taken to perform each measurement is dependent on the number of capacitors in the network 31 in the example illustrated in FIG. 4.

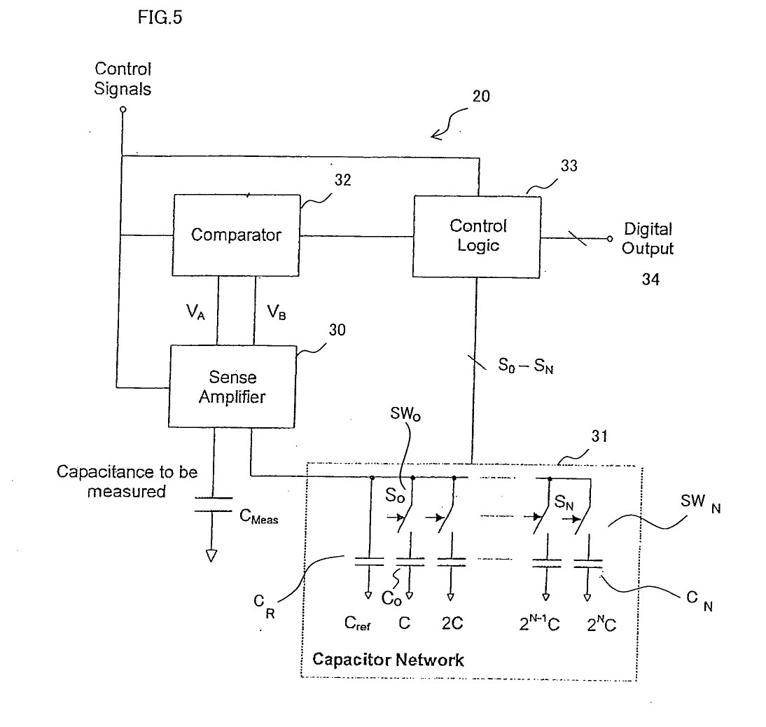

FIG. 5 illustrates another example of the capacitor network 31, which differs from that shown in FIG. 4 in that the binary-weighted switched capacitor arrangement is connected permanently in parallel with a reference capacitor C_{R}. The capacitance C_{ref} of the capacitor C_{R} is preferably chosen to be less than the minimum expected value of the capacitance to be measured by at least the value C of the capacitor C₀ controlled by the least significant bit S₀ of the control logic output. For example, in the case where the apparatus 20 forms part of an AMLCD and is used to determine changes in pixel capacitance to provide a “touch screen” facility, the minimum value of the capacitance to be measured is the minimum expected value of the capacitance of a pixel plus the minimum expected value of the capacitance of the data line and any other connections to the input of the apparatus 20. This minimum expected capacitance should take into account process variations during manufacture, mismatching, temperature effects, and any other effects on the minimum capacitance which could be presented for measurement.

The apparatus 20 of FIG. 5 operates in essentially the same way as the apparatus 20 of FIG. 4. However, comparison between the capacitance to be measured and the capacitance presented by the capacitor network 31 begins not from zero capacitance or the minimum capacitance C but from the capacitance C_{ref} of the reference capacitor C_{R}. Thus, for the same resolution, a smaller switched capacitance network with fewer capacitors and switches may be used and each measurement requires less time. Conversely, the minimum capacitance C of the switched network may be reduced in order to achieve higher resolution. Thus, resolution may be increased and/or system complexity, substrate area and measurement time may be reduced as compared with the apparatus shown in FIG. 4.

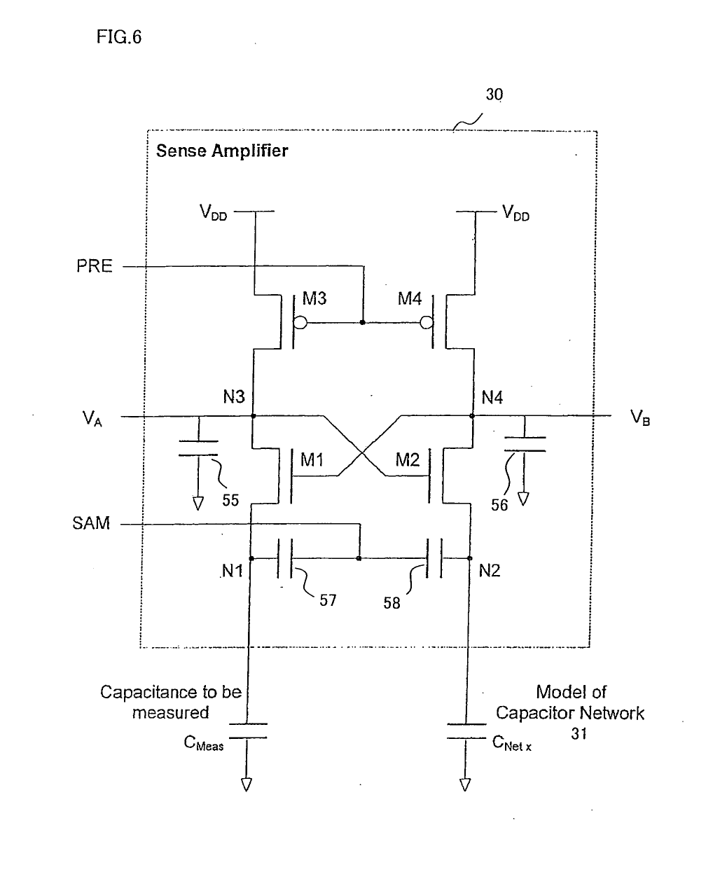

FIG. 6 illustrates an example of the sense amplifier 30 embodied as a charge transfer amplifier. The charge transfer amplifier may be of any suitable design, for example of the type disclosed in Morimura et al, “A Novel Sense of Cell Architecture and Sensing Circuits Scheme for Capacitive Fingerprint Sensors”, IEE Journal of Solid-State Circuits, vol 35 no 5, May 2000. The charge amplifier comprises complementary metal oxide silicon field effect transistors (MOSFETs) M1-M4, capacitors 55 and 56 of the same value, and capacitors 57 and 58 of the same value. The transistors M3 and M4 have sources connected to a power supply line V_{DD}, gates connected together and to a pre-charge control line PRE, and drains connected to nodes N3 and N4, respectively. The nodes N3 and N4 supply the sense amplifier outputs V_{A} and V_{B} and are connected to the capacitors 55 and 56 and to drains of the transistors M1 and M2, respectively. The bases of the transistors M1 and M2 are connected to the nodes N4 and N3, respectively. The sources of the transistors M1 and M2 are connected to circuit nodes N1 and N2, to the capacitors 57 and 58, and to the capacitance to be measured and the capacitor network 31, respectively. The capacitors 57 and 58 are connected together and to a sample control input SAM.

One cycle of operation of the amplifier 30 comprises three phases, namely: pre-charge, sample and hold. The operation of each phase is as follows:

During the pre-charge phase, N₃ and N₄ are pre-charged to the supply voltage V_{DD}. The nodes N₁ and N₂ rise to V_{DD}-V_{T1} and V_{DD}-V_{T2}, respectively, through transistors M1 and M2, where V_{Tx} is the threshold voltage of the transistor Mx.

During the sample phase, a fixed charge ΔQ is discharged from N₁ and N₂ through the capacitors 57 and 58 and the voltage at both nodes is reduced. If C_{Net}<C_{Meas}, the resulting voltage decrease at N₂, ΔV₂, will be larger than that at N₁, ΔV₁, such that ΔV₂>ΔV₁. Charge now begins to be transferred from N₃ to N₁ and from N₄ to N₂. Since the voltage at N₁ is higher than that at N₂, transistor M1 is less conductive than M2 and the charge transfer rate from N₃ to N₁, ΔQ₁, will be smaller than that from N₄ to N₂, ΔQ₂. Consequently, the voltage at node N₄, V_{B}, will fall faster than that at N₃, V_{A}, and charge transfer from N₃ will terminate first since, as V_{B} falls, the gate-source voltage of M1 approaches V_{T1} and M1 is cut-off. The voltage at N₃, V_{A}, and hence the gate of M2, is now fixed. Since the gate voltage of M2 is now fixed, charge transfer continues to occur from N₄ to N₂. The transfer will continue until the voltage at N₂ rises such that the either the gate-source voltage of M2 becomes equal to V_{T2} or the voltage at N₂ becomes equal to that at N₄, V_{B}.

During the hold phase, the voltages at the nodes N₁ to N₄ are fixed and the conversion cycle is complete. For the case C_{Net}<C_{Meas}, V_{A}>V_{B}. Similarly, for the case C_{Net}>C_{Meas}, V_{A}<V_{B}. The charge transfer amplifier 30 thus performs a capacitance to voltage conversion.

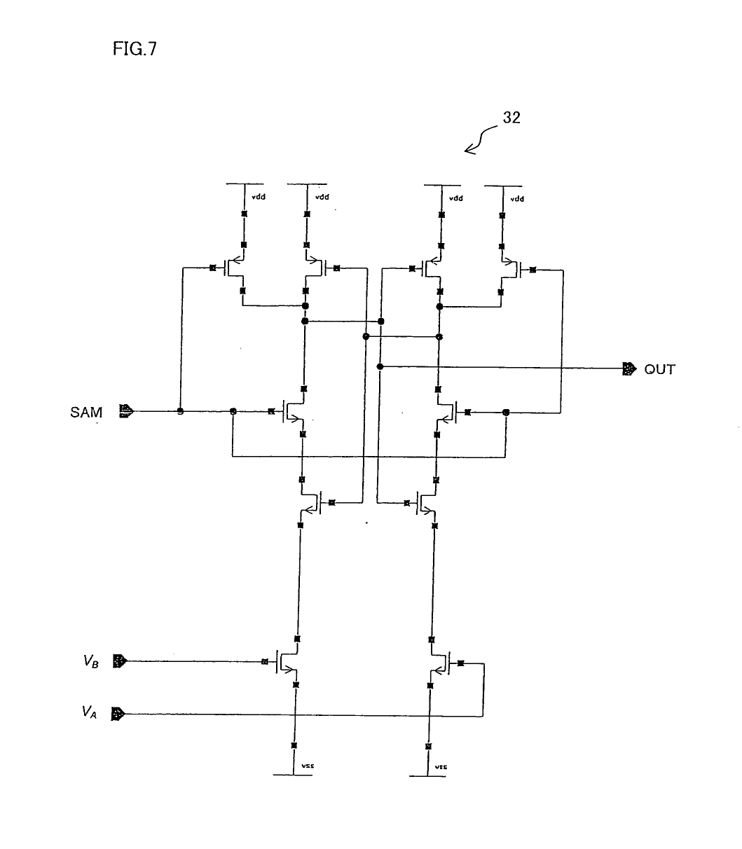

The comparator 32 may be of any suitable type for converting the polarity of the difference between the output voltages V_{A} and V_{B} into a digital signal. One example of a suitable comparator is illustrated in FIG. 7 and comprises a dynamic latch circuit. Such a circuit is well known and is disclosed, for example, in “Introduction to CMOS Op-Amps and Comparators”, R. Gregorian, Wiley 1999.

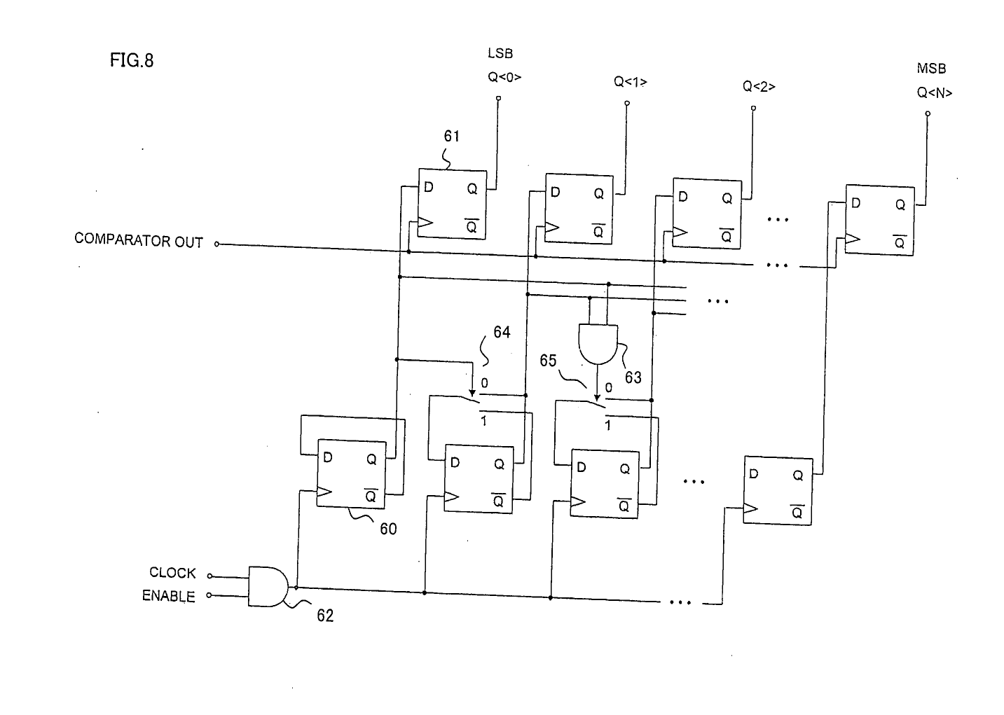

The control logic 33 may comprise an (N+1) bit binary counter and an example of such a counter is illustrated in FIG. 8. The number of bits is determined by the number X of states of the capacitor network 31 and is given by log₂X.

The counter comprises (N+1) stages, each of which comprises a D-type flip-flop counter stage, such as 60, and a D-type flip-flop latch stage such as 61. The latch flip-flops such as 61 have clock inputs which receive a “comparator out” signal from the comparator 32 so that the latch supplies the digital word Q<0>, . . . , Q<N> at the output 34 of the apparatus 20. The data inputs D of the latch flip-flops such as 61 are connected to the Q outputs of the counter flip-flops such as 60.

The counter further comprises gates such as 62 and 63 and electronic switches such as 64 and 65 for controlling operation of the counter. The gate 62 has an enable input for enabling the counter and a clock input for receiving clock pulses, which are supplied to the clock inputs of the counter flip-flops such as 60. Operation of a counter of this type is well known and will not be described further.

The operation of the counter shown in FIG. 8 as the control logic 33 is as follows.

When the control logic 33 is reset at the start of every capacitance measurement sequence, the counter is enabled and its output is set to zero. A first sense amplifier operation cycle is now performed.

If the comparator output is high during the hold phase of the first sense amplifier operation cycle, the counter is disabled and the conversion is complete but in error. The counter may be arranged to generate an ‘out-of-range’ error signal in this case.

If the comparator output remains low during the hold phase of the first sense amplifier operation cycle, the counter is incremented by one count. The state of the capacitor network 31 is thus advanced by one state and an increased capacitance is presented to the input of the sense amplifier 30. The sense amplifier operation cycle is repeated.

For every subsequent hold phase of the sense amplifier operation cycle:

(a) if the comparator output is high, the counter is disabled and the conversion is complete. The value held on the counter output at this point corresponds to the state of the capacitor network 31 and thus the value of the capacitance being measured;

(b) if the comparator output remains low, the counter is incremented and the sense amplifier operation cycle repeated.

If the final state of the capacitor network is reached and the comparator output remains low during the corresponding sense amplifier hold phase, then the capacitance measurement operation may be taken as being complete but in error. The counter may be arranged to generate an ‘out-of-range’ error signal in this case.

The maximum time taken for the capacitance measurement sequence, tₘₐₓ, is therefore an exponential relationship: tₘₐₓ=tₐₘₚ×2^{N}, where tamp is the time taken for one sense amplifier operation cycle.

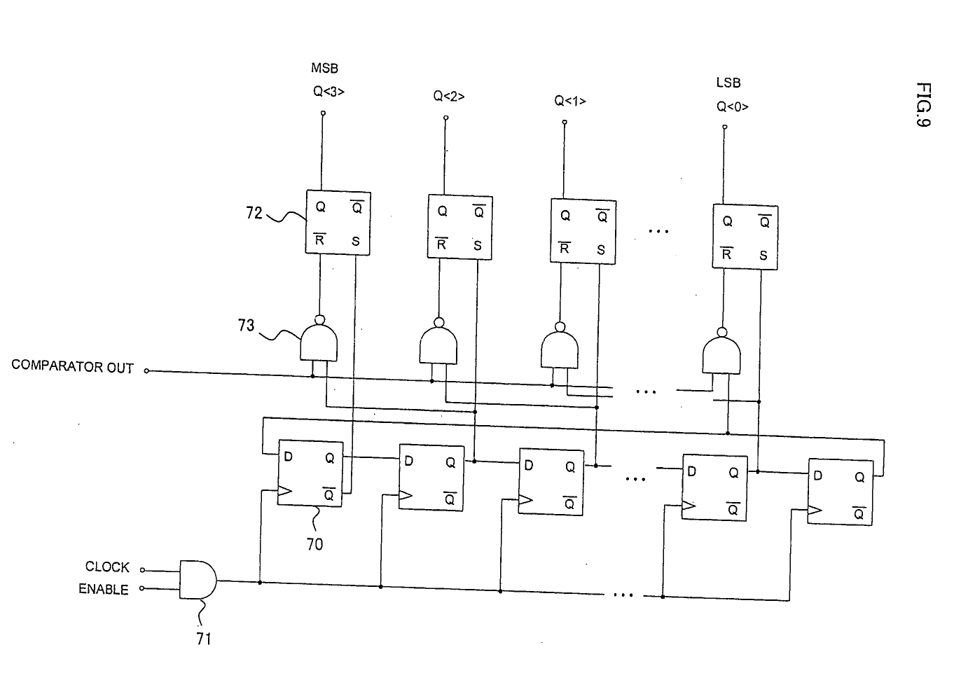

FIG. 9 illustrates an alternative form of the control logic 33 in the form of a successive approximation register (SAR). The length of the register is equal to log₂X. The SAR comprises a shift register formed by D-type flip-flops such as 70 connected in a ring and arranged to circulate a single “1” bit in synchronism with clock signals supplied to the clock inputs of the flip-flops. The clock signals are supplied by a gate 71 with inputs for receiving clock pulses and an enable signal.

The SAR further comprises set/reset flip-flops such as 72 having inverted reset inputs connected to the outputs of NAND gates such as 73 and set inputs connected to outputs of the shift register flip-flops. The gates 73 have first inputs for receiving the comparator output and second inputs connected to the shift register outputs.

The operation of the SAR of FIG. 9 as the control logic 33 is as follows. When the SAR is reset at the start of every capacitance measurement sequence, the most significant bit of the SAR causes the highest value capacitor C_{N} of the capacitor network 31 to be connected. The sense amplifier 30 performs a capacitance comparison and the comparator 32 supplies a signal indicating whether the capacitance to be measured is greater than or less than the capacitance presented by the capacitor network 31. If the capacitance to be measured is greater than the capacitance presented by the network 31, the flip-flop 72 remains set. Conversely, if the capacitance to be measured is less than the capacitance presented by the network 31, the flip-flop 72 is reset.

This sequence is repeated for each stage of the SAR so as to complete the capacitance measurement. The time tₘₐₓ taken to complete each capacitance measurement is thus given by tₐₘₚ×N, and is generally substantially less than for the counter arrangement illustrated in FIG. 8.

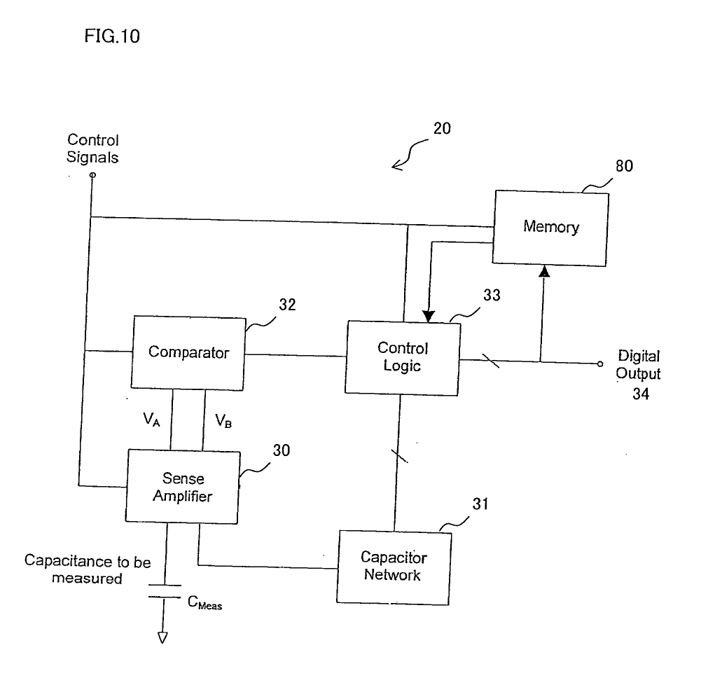

FIG. 10 illustrates a capacitance measuring apparatus 20 which differs from that shown in FIG. 2 in that a memory 80 is provided and capacitance measurement is performed in two stages, namely a calibration stage and a measurement stage. The memory 80 is controlled so as to store the control logic output at the end of the calibration stage and to return this to the control logic 33 at the first cycle of the measurement stage.

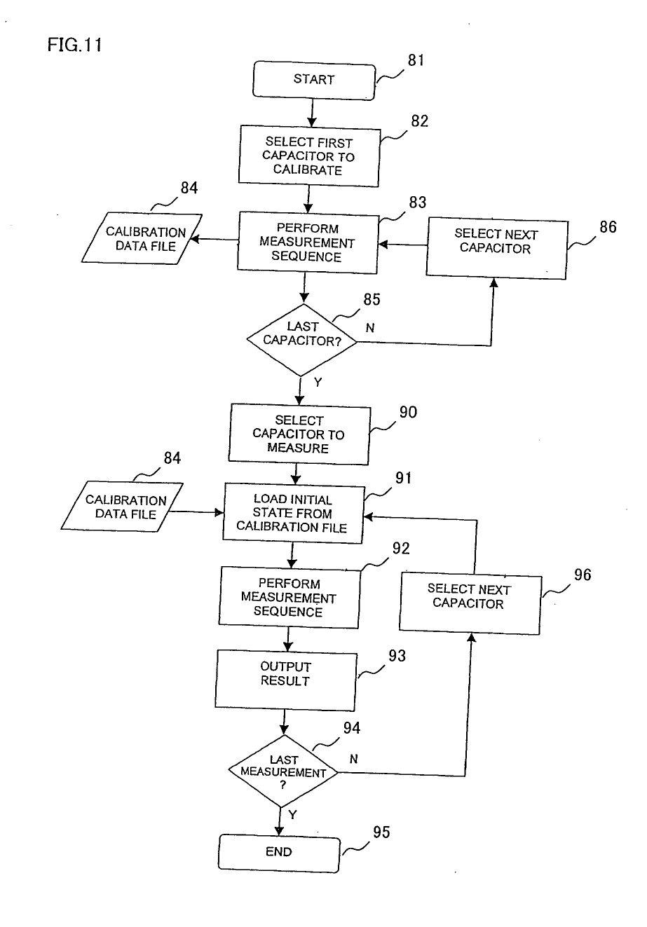

Operation of the apparatus 20 of FIG. 10 is illustrated in FIG. 11. The calibration stage starts at 81 and a capacitor or a first capacitor to calibrate is selected at 82. For example, where the apparatus 20 is used in the AMLCD shown in FIG. 1, the first capacitor to calibrate may be the first pixel whose capacitance (in parallel with the data line capacitance and any other relevant capacitance), is to be measured in the absence of any external stimulus. Alternatively, the first capacitor to calibrate may comprise the data line and any other parasitic capacitance used to connect to pixels 10 of the display.

At 83, a measurement as illustrated in FIG. 3 is performed and the result is stored in a calibration data file 84 in the memory 80. A step 85 checks whether the last capacitor has been calibrated and, if not, the next capacitor is selected at 86 and the measurement sequence 83 is repeated. Once all of the capacitors for calibration have been measured, the calibration stage is complete and the measurement stage begins.

As mentioned above, all of the pixel capacitances which occur when no external stimulus is applied to the display can be determined in this way and stored. Each pixel value may then be used as the starting point for measurement of the capacitance of that pixel. Alternatively, to reduce memory requirements, the data line capacitances without the pixel capacitances may be measured and stored for subsequent use as the starting point in pixel capacitance measurements.

During the measurement phase, the first capacitance to be measured is selected at 90 and, at 91, the initial state of the control logic 33 is loaded from the calibration file 84 held in the memory 80. The measurement sequence illustrated in FIG. 3 is performed at 92 and the result is output at 93. A step 94 determines whether the last measurement has been made and, if so, the measurement stage ends at 95. If not, the next capacitor to be measured is selected at 96 and the initial state for that capacitor is loaded from the calibration file 84 in the step 91. Thus, the steps 91 to 93 are repeated for each measurement with the appropriate initial state of the capacitor network 31 being loaded for each capacitance to be measured.

By performing the calibration stage with the AMLCD “untouched” so as to measure the minumum capacitance values of the pixels, the time required for each measurement during the measurement stage can be reduced. The calibration stage may, for example, be performed immediately after each power-up of the AMLCD or may be performed more regularly, for example so as to account for temporal variations, for example resulting from temperature changes.

Although the use of a capacitance measuring apparatus has been described in the context of an AMLCD, the apparatus is not limited to such use. For example, such an apparatus may be used in applications where it is necessary to measure a relatively small capacitance change superimposed on a relatively large parasitic capacitance. Such a measurement may be performed in an active matrix device or in any other suitable arrangement.

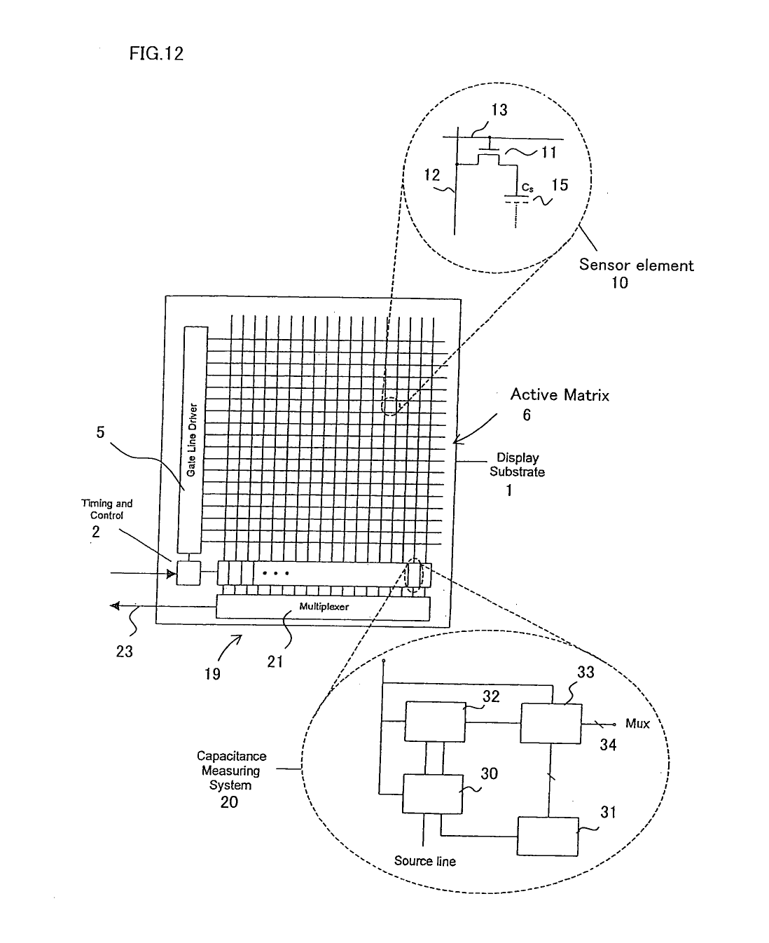

FIG. 12 illustrates an example of the use of this technique in an active matrix device which is not part of a display. This device may be used, for example, as a capacitive fingerprint sensor to determine the locations of ridges and valleys on a finger which is in contact with a sensing surface of the device.

The device shown in FIG. 12 is similar to that shown in FIG. 1 but differs in that the liquid crystal layer, the counter substrate and the display source drivers are omitted. Also, each pixel 10 of FIG. 1 is replaced by a sensor element so that the liquid crystal pixel image generating element 14 is omitted and the parallel storage capacitor 15 is replaced by an electrode, which cooperates with an overlying material such as a finger to provide a capacitance to be measured.

In use, any of the previously described scanning modes (omitting display refresh operations) may be performed and the circuits 30 to 33 may be embodied as described hereinbefore. For example, the gate line driver 5 may apply scan signals to each row electrode 13 of the active matrix 6 in turn and the capacitance measuring apparatuses or systems 20 determine the capacitances of the sensor elements 10 superimposed on the parasitic capacitances a row at a time. The electrodes 15 cooperate with the overlying material such as a finger to form a capacitance to be measured. When used to determine a fingerprint, those electrodes 15 overlayed by a fingerprint ridge present a higher capacitance than those overlayed by a fingerprint valley. The measured capacitances can thus be used to determine the positions of ridges and valleys in the fingerprint and this information may, for example, be compared with stored fingerprint data to determine the identity of or to validate a fingerprint.

What is claimed is:

1. An apparatus for measuring a capacitance, said apparatus comprising a capacitor network having a plurality of states presenting respective different capacitances, a sense amplifier for comparing a capacitance to be measured with a capacitance of said network and for supplying an output representative of whether said capacitance to be measured is larger than said capacitance of said network, and a control circuit responsive to said output of said sense amplifier to select among said states of said network and to supply a digital measurement output corresponding to said state in which said network has a capacitance adjacent said capacitance to be measured.

2. An apparatus as claimed in claim 1, in which said sense amplifier has a measurement cycle comprising charging said capacitance to be measured and said capacitor network to a same voltage, changing charges in said capacitance to be measured and in said capacitor network by a same amount, and comparing voltages on said capacitance to be measured and said capacitor network.

3. An apparatus as claimed in claim 2, in which said sense amplifier comprises a charge transfer amplifier.

4. An apparatus as claimed in claim 1, in which said capacitor network comprises a plurality of electronic switches and a plurality of capacitors connectable in parallel via said electronic switches.

5. An apparatus as claimed in claim 4, in which said capacitors have binary-weighted capacitances.

6. An apparatus as claimed in claim 4, in which said capacitor network comprises a further permanently connected capacitor.

7. An apparatus as claimed in claim 1, comprising a voltage comparator connected to said output of said sense amplifier.

8. An apparatus as claimed in claim 7, in which said voltage comparator comprises a dynamic latch.

9. An apparatus as claimed in claim 1, comprising a memory for storing a calibration value from said control circuit during a calibration phase of operation and for presenting said calibration value to said capacitor network at a start of a measurement phase of operation.

10. An apparatus as claimed in claim 1, in which said control circuit comprises a counter having outputs arranged to select said capacitor network states.

11. An apparatus as claimed in claim 10, in which said counter is arranged to step monotonically through said capacitances until said output of said sense amplifier changes state.

12. An apparatus as claimed in claim 1, in which said control circuit comprises a successive approximation register having outputs arranged to select said capacitor network states.

13. A sensor array comprising: an array of sensor elements, each of which comprises an electrode for cooperating with an overlying material to form a capacitor; at least one apparatus for measuring a capacitance, said at least one apparatus comprising a capacitor network having a plurality of states presenting respective different capacitances, a sense amplifier for comparing a capacitance to be measured with a capacitance of said network and for supplying an output representative of whether said capacitance to be measured is larger than said capacitance of said network, and a control circuit responsive to said output of said sense amplifier to select among said states of said network and to supply a digital measurement output corresponding to said state in which said network has a capacitance adjacent said capacitance to be measured; and a switching network for connecting said electrodes to said at least one apparatus.

14. An array as claimed in claim 13, in which said switching network is arranged to connect said electrodes one at a time to said at least one apparatus.

15. An array as claimed in claim 13, in which said switching network comprises an active matrix.

16. An array as claimed in claim 15, comprising: an active matrix display in which said sensor elements comprise picture elements arranged as rows and columns, each said picture element having a display data input for receiving image data to be displayed and a scan input for enabling input of said image data from said data input, said display comprising column data lines and row scan lines, said data inputs of said picture elements of each said column being connected to a respective said column data line and said scan inputs of said picture elements of each said row being connected to a respective said row scan line; a data signal generator for supplying data signals to said column data lines; a scan signal generator for supplying scan signals to said row scan lines; and an output arrangement connected to said column data lines and responsive to sensor signals generated by and within said display picture elements in response to external stimuli, said output arrangement comprising said at least one apparatus which is arranged to measure data line and picture element capacitance.

17. An array as claimed in claim 16, comprising a display substrate on which are integrated said data signal generator, said scan signal generator, and said output arrangement.

18. An array as claimed in claim 16, in which each said picture element comprises an image generating element and an electronic switch.

19. An array as claimed in claim 18, in which each said image generating element comprises a liquid crystal element.

20. An array as claimed in claims 13, in which said at least one apparatus comprises a memory for storing a calibration value from said control circuit during a calibration phase of operation and for presenting said calibration value to said capacitor network at a start of a measurement phase of operation, said at least one apparatus being arranged to perform said calibration phase periodically in the absence of external stimuli.

21. An array as claimed in claim 20, in which said at least one apparatus is arranged to perform said calibration phase at least at a switch-on of said array.
